(19) United States
(12) Patent Application Publication
(10) Pub. No.: US 2006/0259855 A1
(43) Pub. Date: Nov. 16, 2006

(54) System and method for organizing multiple images using templates

(75) Inventor: Kevin M. Crucs, Akron, OH (US)

Correspondence Address: HAHN LOESER & PARKS, LLP, One GOJO Plaza, Suite 300, AKRON, OH, 44311-1076, US

(73) Assignee: APTERYX, INC.

(21) Appl. No.: 11/125,931

(22) Filed: May 10, 2005

(51) Int. Cl. G06F 17/00

(52) U.S. Cl. 715/517

(57) ABSTRACT

A system and method for organizing medical images as a single page representation are disclosed. The system comprises a computer-based platform hosting a patient management software application. The computer-based platform is used for displaying at least two digital medical images in at least one application window of the patient management software application. Each of the digital medical images is identified as being of a particular type of medical image. The computer-based platform is further used for displaying at least two page representation templates in at least one other application window of the patient management software application. Each of the page representation templates includes pre-defined, blank image holder areas which are each defined as corresponding to a particular type of medical image. The computer-based platform is also used for selecting one of the page representation templates based on at least one of the type and number of the displayed medical images. The computer-based platform is further used for importing the digital medical images into the selected page representation template. Each of the medical images is associated with one of the pre-defined image holder areas based on at least the medical image type. The computer-based platform is also used for displaying the selected page representation template having the imported medical images in an application window of the patient management software application. Each of the imported medical images is automatically sized and displayed in an associated image holder area of the selected template.

### TECHNICAL FIELD

Certain embodiments of the present invention relate to the management of patient information. More particularly, certain embodiments of the present invention relate to a system and method to organize patient medical images in a single page representation, for example, for printing.

### BACKGROUND OF THE INVENTION

Patient management systems often incorporate an ability to manage, display, and print digital medical images that have been captured using some form of medical imaging machine. However, multiple images captured from a single patient are often stored and displayed to a user (e.g., a medical doctor) in a manner that is less than desirable to the user.

When a user displays a series of digital medical images on a display, the user may desire to print the entire series of medical images on a single page. However, this may not be possible or, if possible, the arrangement and sizing of the medical images on the single page may be less than adequate, in the opinion of the user.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention provides a method of organizing medical images for representation on a single page. The method comprises displaying at least two digital medical images in at least one application window of a patient management software application of a computer-based system. Each of the digital medical images is identified as being of a particular type of medical image. The method also comprises displaying at least two page representation templates in at least one other application window of the patient management software application. Each of the page representation templates includes pre-defined, blank image holder areas which are each defined as corresponding to a particular type of medical image. The method further comprises selecting one of the page representation templates based on at least one of the type and number of the displayed medical images. The method also comprises importing the digital medical images into the selected page representation template. Each of the medical images is associated with one of the pre-defined image holder areas based on at least the medical image type. The method further comprises displaying the selected page representation template having the imported medical images in an application window of the patient management software application. Each of the imported medical images is automatically sized and displayed in an associated image holder area of the selected template.

Another embodiment of the present invention comprises a system for organizing medical images for representation on a single page. The system comprises a computer-based platform hosting a patient management software application. The computer-based platform is used for displaying at least two digital medical images in at least one application window of the patient management software application. Each of the digital medical images is identified as being of a particular type of medical image. The computer-based platform is further used for displaying at least two page representation templates in at least one other application window of the patient management software application. Each of the page representation templates includes pre-defined, blank image holder areas which are each defined as corresponding to a particular type of medical image. The computer-based platform is also used for selecting one of the page representation templates based on at least one of the type and number of the displayed medical images. The computer-based platform is further used for importing the digital medical images into the selected page representation template. Each of the medical images is associated with one of the pre-defined image holder areas based on at least the medical image type. The computer-based platform is also used for displaying the selected page representation template having the imported medical images in an application window of the patient management software application. Each of the imported medical images is automatically sized and displayed in an associated image holder area of the selected template.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a schematic block diagram of an exemplary embodiment of a system for organizing medical images, in accordance with various aspects of the present invention.

FIG. 2 is a flowchart of an exemplary embodiment of a method for organizing medical images using at least a portion of the system of FIG. 1, in accordance with various aspects of the present invention.

FIG. 3 is a schematic diagram of an exemplary embodiment of an application window of a patient management software application displaying a plurality of medical images of two image types, in accordance with various aspects of the present invention.

FIG. 4 is a schematic diagram of an exemplary embodiment of three page representation templates being displayed in an application window of a patient management software application, in accordance with various aspects of the present invention.

FIG. 5 is an exemplary embodiment of an application window of a patient management software application, displaying a plurality of unorganized dental X-ray images of three image types, in accordance with various aspects of the present invention.

FIG. 6 is an exemplary embodiment of a selected page representation template displaying the dental X-ray images imported from the application window of FIG. 5, in an organized manner, in another application window of the patient management software application, in accordance with various aspects of the present invention.

FIG. 7 is a schematic diagram of an exemplary embodiment of a selected page representation template displaying two types of medical images, and showing how two of the medical images may be manually resized, in accordance with various aspects of the present invention.

### DETAILED DESCRIPTION OF THE INVENTION

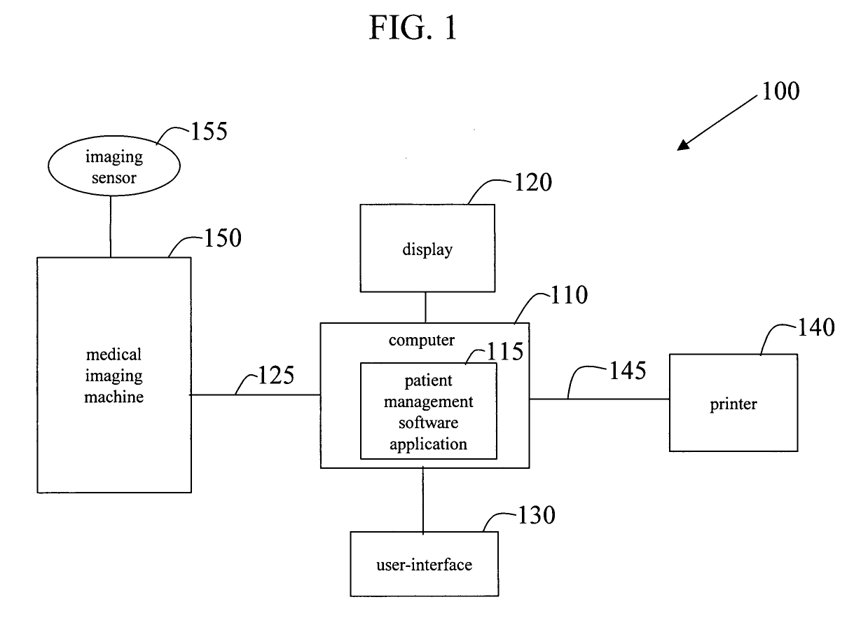

FIG. 1 is a schematic block diagram of an exemplary embodiment of a system 100 for organizing medical images, in accordance with various aspects of the present invention. The general idea is to use pre-defined page representation templates to organize digital medical images on a single page. The system includes a computer 110 hosting a patient management software application 115. The computer 110 may include any processor-based platform such as, for example, a personal computer (PC) or a work-station. The patient management software application 115 may include any software application that can run on the computer 110 and which is able to perform at least the various functions described herein that are attributed to the patient management software application 115.

The system 100 also includes a display 120 and a user interface 130 which are operationally connected to the computer 110. The display 120 may include a CRT monitor, an LCD flat panel array, or any other type of display, in accordance with various embodiments of the present invention. The display 120 may or may not be an integral part of the computer 110, in accordance with various embodiments of the present invention. The user interface 130 may include at least one of a keyboard, a mouse, a touch-screen display, or any other mechanism that allows a user to control the computer 110 and the patient management software application 115 running on the computer 110, in accordance with various embodiments of the present invention. The user interface 130 may or may not be an integral part of the computer 110, in accordance with various embodiments of the present invention.

The system 100 further includes a printer 140 for printing hard copies of medical images that are organized into predefined templates by the patient management software application 115 at the command of a user of the computer 110. The printer 140 may be of any various types including a laser printer, an ink jet printer, a color printer, a gray-scale printer, a medical film printer, or any other type of printer that is capable of generating and outputting a physical hard copy of a page representation of medical images, in accordance with various aspects of the present invention.

In accordance with certain embodiments of the present invention, the system 100 may include a medical imaging machine 150 which interfaces to a medical imaging sensor 155. The medical imaging machine 150 operationally interfaces to the computer 110 in order to transmit (i.e., download) digital medical images, captured by the medical imaging machine 150, to the computer 110. The medical imaging machine 150 may be any type of medical imaging machine such as, for example, an intra-oral X-ray machine, a pan-oral X-ray machine, a computed tomography (CT) machine, an ultrasound machine, a thermal imaging machine, a magnetic resonance (MR) imaging machine, or any other type of medical imaging machine that is used to image at least one portion of a person's body. The computer 110 may be an integral part of the imaging machine 150, in accordance with various embodiments of the present invention.

The interface 145 between the computer 110 and the printer 140 may be a wired or wireless interface, in accordance with various embodiments of the present invention. Also, the interface 145 may be a network interface such as a local area network (LAN) interface, a wide area network (WAN) interface, a DICOM interface, the Internet, or any other type of network interface, in accordance with various embodiments of the present invention.

Similarly, the interface 125 between the computer 110 and the medical imaging machine 150 may be a wired or wireless interface, in accordance with various embodiments of the present invention. Also, the interface 125 may be a network interface such as a local area network (LAN) interface, a wide area network (WAN) interface, a DICOM interface, the Internet, or any other type of network interface, in accordance with various embodiments of the present invention.

The imaging sensor 155 may be, for example, a digital X-ray sensor, an ultrasound probe, a thermal imaging sensor, a digital camera, an RF sensor (e.g., an MR coil), or any other type of imaging sensor that may interface to the medical imaging machine 150 in order to capture medical images of a particular imaging modality type.

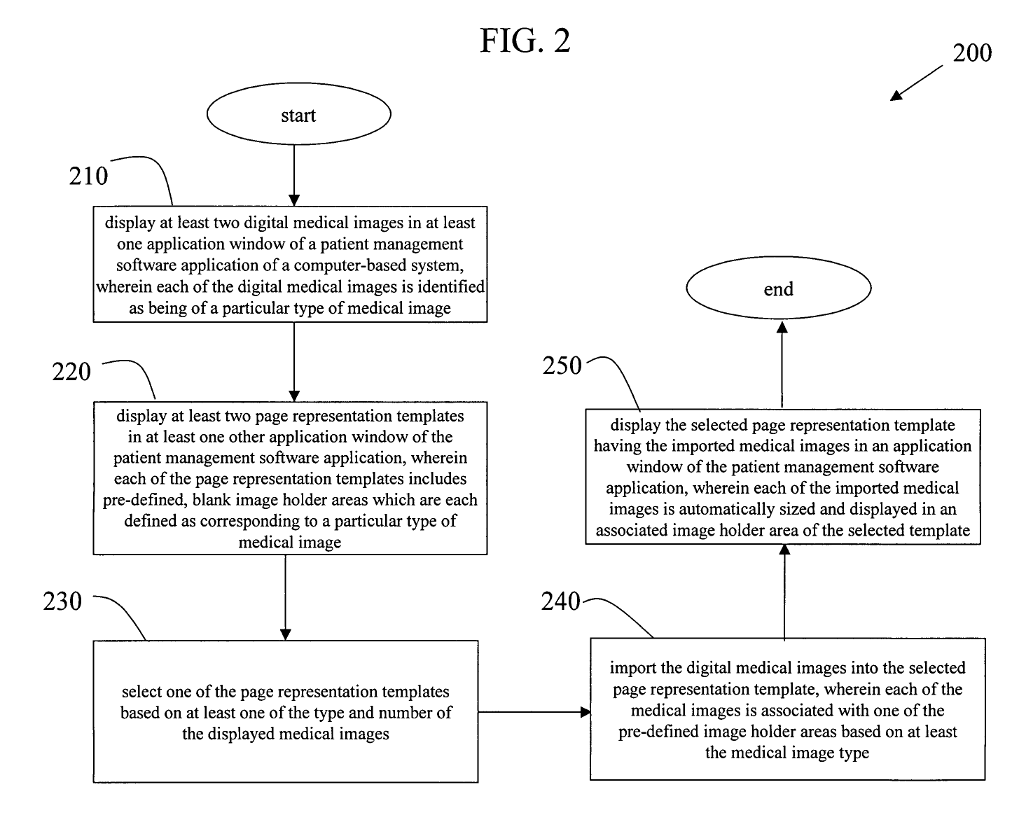

FIG. 2 is a flowchart of an exemplary embodiment of a method 200 for organizing medical images using at least a portion of the system 100 of FIG. 1, in accordance with various aspects of the present invention. In step 210, at least two digital medical images are displayed in at least one application window of a patient management software application of a computer-based system. Each of the digital medical images is identified as being of a particular type of medical image. In step 220, at least two page representation templates are displayed in at least one other application window of the patient management software application. Each of the page representation templates includes pre-defined, blank holder areas which are each defined as corresponding to a particular type of medical image. In step 230, one of the page representation templates is selected by a user based on at least one of the type and number of the displayed medical images. In step 240, the digital medical images are imported into the selected page representation template. Each of the medical images is associated with one of the pre-defined image holder areas based on at least the medical image type. In step 250, the selected page representation template is displayed, having the imported medical images, in an application window of the patient management software application. Each of the imported medical images is automatically sized and displayed in an associated image holder area of the selected template.

In the patient management software application 115, each medical image is defined as being of a certain type. Medical image types may take many forms, in accordance with various embodiments of the present invention. For example, a medical image type may be defined according to a size of a medical image. For certain medical imaging applications, certain standard imaging sizes may be provided. As another example, a medical image type may be defined according to the imaging modality. For example, a first medical imaging type may be defined as an intra-oral (IO) X-ray image type. A second medical imaging type may be defined as a pan-oral (PX) X-ray image type. Other image types based on modality are possible as well. For example, other image types may include X-ray image types, computed tomography (CT) image types, magnetic resonance (MR) image types, ultrasound image types, thermal (e.g., infrared) image types, etc. Other image types that are not based on modality or size may be possible as well, in accordance with various embodiments of the present invention. For example, an image type may be defined based on anatomy. For example, image type may be defined based on the particular teeth that have been captured in an image (e.g., 3 particular adjacent teeth in a human patient's mouth).

The blank image holder areas discussed in the method 200 of FIG. 2 have pre-defined image types as well. That is, only images being of a same image type as the image type of a particular image holder area may be imported into that image holder area. Therefore, the image types of the image holder areas of the page representation templates have the same image types as that of the digital medical images themselves.

In step 230 of the method 200, a user selects a page representation template based on his personal preference. The image holder areas are arranged in a pre-defined configuration within a template. The selection may be done via the user-interface 130 (e.g., using a mouse). The user may be somewhat restricted, however, on which template he may select. For example, in general, the image types of the image holder areas of the selected template should match the image types of the medical images to be imported. Also, in general, the number of images to be imported into the selected template should match the number of image holder areas defined for the selected template. In accordance with an embodiment of the present invention, the only templates that will be available for selection are those templates that match the images to be imported with respect to image type and the number of images.

However, certain features may be provided by the patient management software application that allow deviations from such general restrictions. For example, if a selected template includes five image holder areas and the user wishes to import only four medical images, the four medical images may be imported into the selected template, leaving one of the image holder areas as being blank or unpopulated. Also, for example, if there are more images to be imported than there are image holder areas in the selected template, then the patient management software application may ask the user to select the exact images to be imported or the exact images to not be imported from the original set of images.

Other strategies are possible as well when the number of images and/or image types don't exactly match the selected template. For example, if a set of medical images includes five intra-oral images and one pan-oral image, and a selected template includes image holder areas for only five intra-oral images, then the five intra-oral images may be imported into the selected template, leaving the pan-oral image as being un-imported. In such an instance, the patient management software application may ask the user what he wishes to do with the un-imported pan-oral image, if anything. For example, the user may be given the option to print the pan-oral image on a separate single sheet or save the pan-oral image as a document (e.g., a PDF document). Or, the user may be given the option to import the pan-oral image into another template. Other options are possible as well, in accordance with various other embodiments of the present invention.

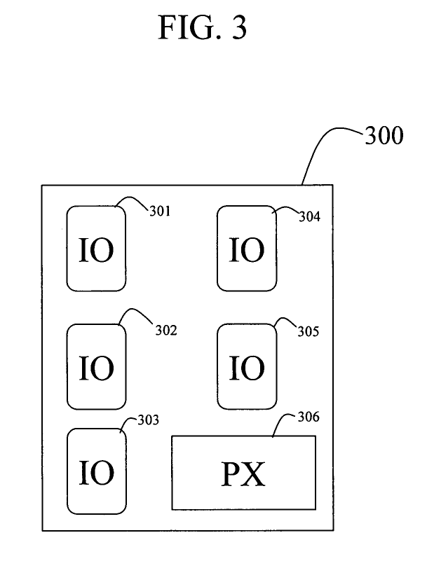

FIG. 3 is a schematic diagram of an exemplary embodiment of an application window 300 of a patient management software application 115 displaying a plurality of medical images of two image types (IO and PX), in accordance with various aspects of the present invention. There are five intra-oral (IO) images 301-305 displayed in the window 300 and one pan-oral (PX) image 306 displayed in the window 300. These images 301-306 are not displayed in any particular desired order or arrangement in the window 300.

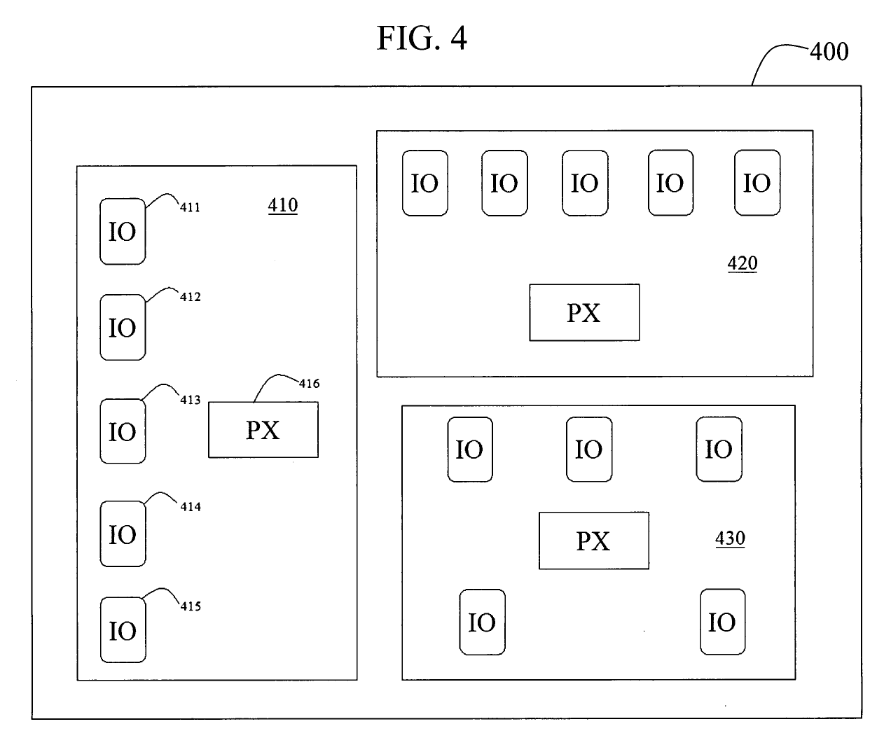

FIG. 4 is a schematic diagram of an exemplary embodiment of three page representation templates (410, 420, 430) each being displayed in an application window of a patient management software application 115, in accordance with various aspects of the present invention. A user of the system 100 of FIG. 1 may select one of the page representation templates (e.g., 410) based on personal preference such that the method 200 of FIG. 2 is employed to import the images 301-306 of FIG. 3 into the selected template and display the images 301-306 according to the pre-defined arrangement of the selected template. The images 301-306 are associated with the pre-defined, blank image holder areas (e.g., 411-416) and are automatically sized, if necessary, based on the pre-defined sizes of the image holder areas (e.g., 411-416).

The process of importing performed in step 240 of the method 200 is accomplished automatically by the patient management software application by associating each image with one available image holder area in the selected template based on image type. However, the automatic importing may be initiated by a user via the user interface 130 (e.g., clicking on an import command icon using a mouse).

Multiple images and multiple image holder areas may be of the same image type. For example, the images 301-305 and the image holder areas 411-415 are of the same image type (intra-oral). Therefore, which image 301-305 will get imported into which image holder area 411-415 may not be apparent to the user until after the importing is accomplished and the populated template is displayed to the user. However, if image type for the images 301-305 and the image holder areas 411-415 were further defined down to specific anatomy such as, for example, specific teeth, then the patient management software application may be able to form an accurate one-to-one correspondence between each image 301-305 and each image holder area 411-415 in such a way that the correspondence is apparent to the user, even before importing occurs.

In accordance with an alternative embodiment of the present invention, the user may manually import images into a selected image template by manually dragging images, one at a time, from a first application window into an image holder area of a second application window displaying the selected template. Such an embodiment may not be as convenient and efficient as automatically importing the images into a template. However, such an embodiment may allow for more user control in “setting up” the final page representation for printing or saving as a document.

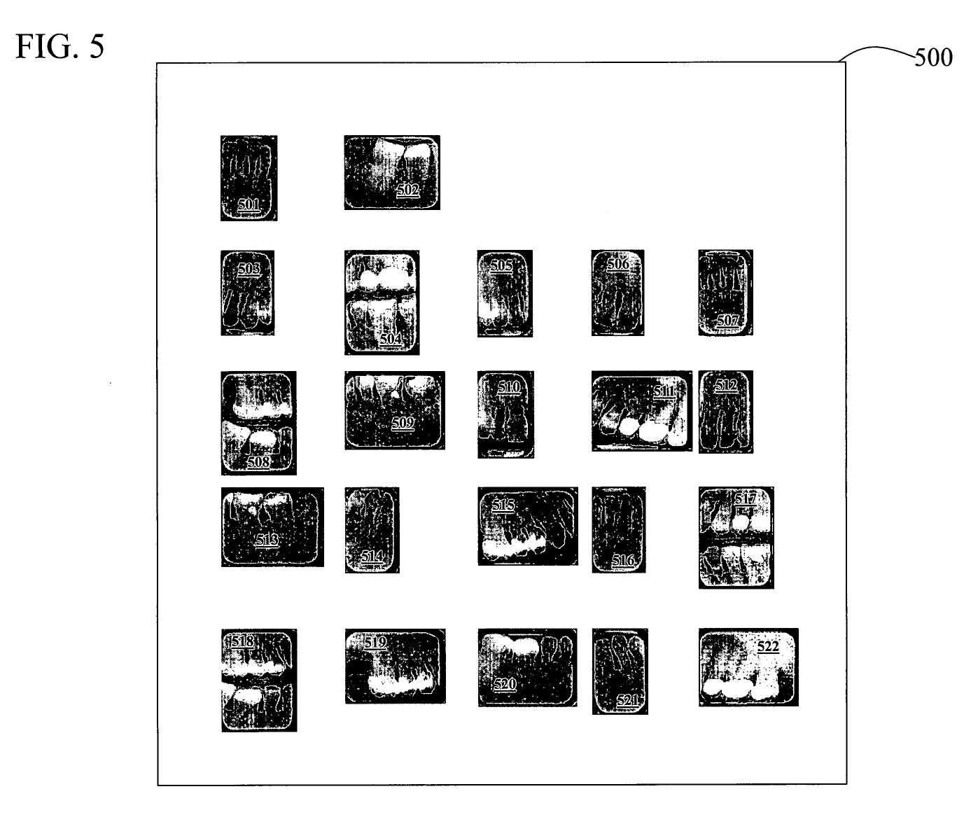

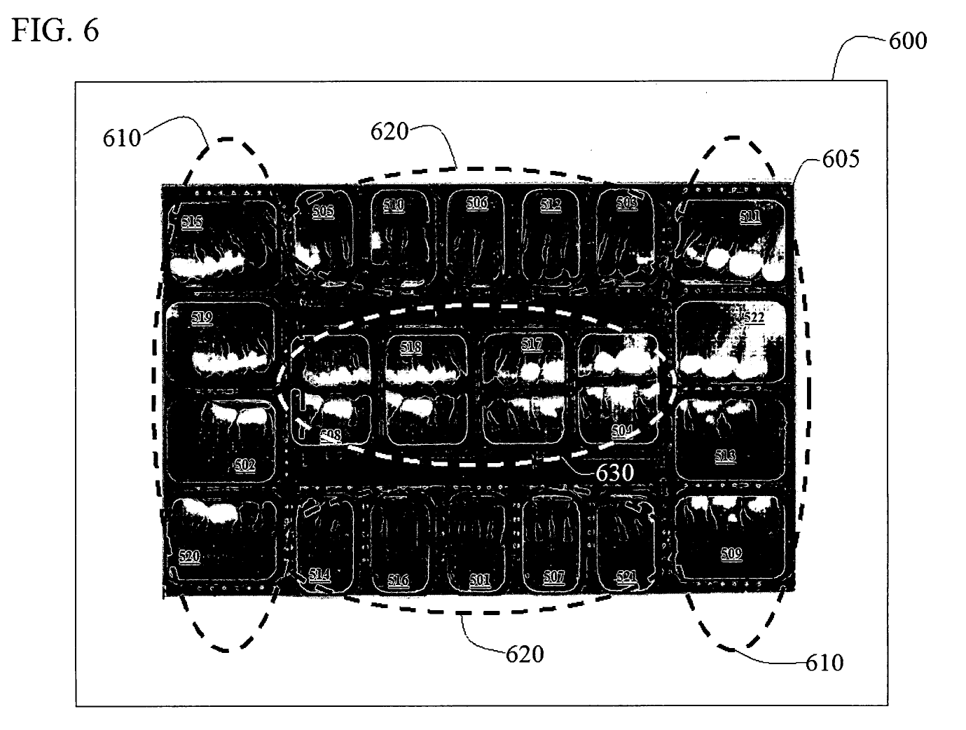

As a more specific example, FIG. 5 is an exemplary embodiment of an application window 500 of a patient management software application 115, displaying a plurality of unorganized dental X-ray images 501-522 of three image types, in accordance with various aspects of the present invention. A user may employ the method 200 of FIG. 2 using the system 100 of FIG. 1 to select a page representation template in order to organize, display, and print the images of FIG. 5 in a more desirable manner. For example, FIG. 6 is an exemplary embodiment of a selected page representation template 605 displaying the dental X-ray images 501-522 imported from the application window 500 of FIG. 5, in an organized manner, in another application window 600 of the patient management software application 115, in accordance with various aspects of the present invention. The three image types (610, 620, 630) are based on the size of the individual images. In accordance with another embodiment of the present invention, the three image types may be based on both image size and anatomy type (e.g., placing the teeth images in correct anatomical location with respect to each other). Again, the images 501-522 of FIG. 5 may be automatically sized, if necessary, to match the sizes of the corresponding image holder areas of FIG. 6.

Once a page representation template is selected and populated with imported images, the populated page representation template may be printed on a printer 140. The images that were imported into the selected page representation template are printed on a single page of a medium (e.g., paper or film) according to the pre-defined arrangement of the template, or any user modifications thereof.

In accordance with various embodiments of the present invention, any populated page representation template may be saved on the system 100 of FIG. 1 (e.g., in memory of the computer 110), maintaining the identify of each individual digital image within the save template. As a result, a user may call up or access the stored file at a later time to, for example, print the file. When a populated page reference template is saved as a file, the original page reference template is not destroyed or over-written in any way. The original page reference template, with blank (i.e., un-populated) image holder areas, is always available to be selected at a later time.

In accordance with various embodiments of the present invention, any populated page representation template may be converted to a single digital image and saved as its own image file on the system 100 of FIG. 1 (e.g., in memory of the computer 110). As a result, a user may call up or access the stored image file at a later time to, for example, print the image file. When a populated page reference template is saved as an image file, the original page reference template is not destroyed or over-written in any way. The original page reference template, with blank (i.e., un-populated) image holder areas, is always available to be selected at a later time.

In accordance with various embodiments of the present invention, any populated page representation template may be converted to a pre-defined document format and saved as its own document file on the system 100 of FIG. 1 (e.g., in memory of the computer 110). As a result, a user may call up or access the stored document file at a later time to, for example, print the document file. When a populated page reference template is saved as a document file, the original page reference template is not destroyed or over-written in any way. The original page reference template, with blank (i.e., un-populated) image holder areas, is always available to be selected at a later time. For example, a populated page representation template may be saved as a document in the well-known .pdf (portable document format) format.

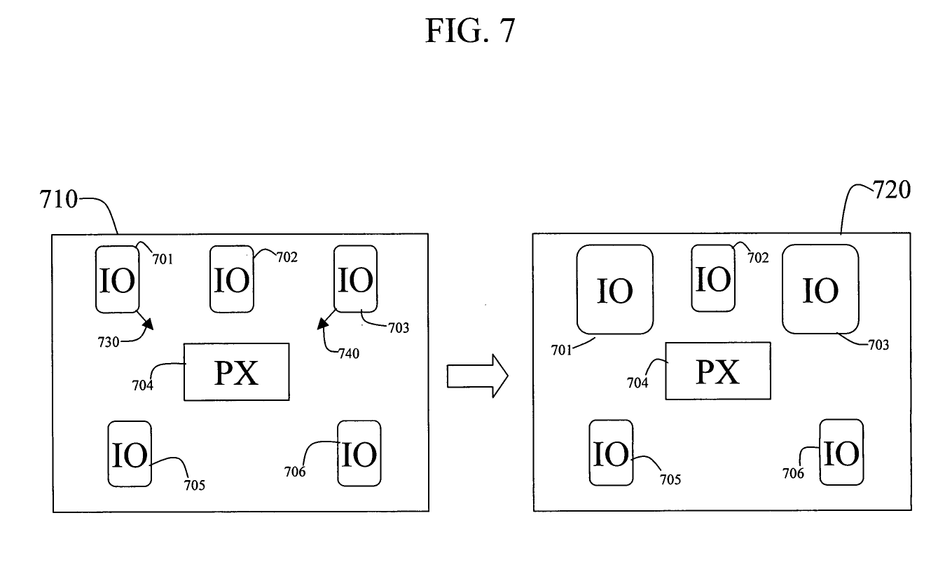

FIG. 7 is a schematic diagram of an exemplary embodiment of a selected page representation template 710 displaying two types of medical images (IO and PX), and showing how two of the medical images (701 and 703) may be manually resized, in accordance with various aspects of the present invention. Once the template 710 has been selected and the images 701-706 have been imported into the selected template 710, any of the images 701-706 may be manually re-sized by the user. For example, the user may use a mouse to click on image 701 and drag the lower right corner diagonally (as indicated by the arrow 730) to enlarge the image 701 as shown in the modified template 720. Similarly, the user may use the mouse to click on the image 703 and drag the lower left corner diagonally (as shown by the arrow 740) to enlarge the image 703 as shown in the modified template 720. As a result, a user may make adjustments to the image sizes after selecting a template and importing the images. In accordance with an alternative embodiment of the present invention, the user may modify the size of the image holder areas of a selected template before importing the images. The images will be automatically re-sized according to the modified sized of the image holder areas when imported.

In summary, embodiments of the present invention provide a system and method to organize multiple medical images on a single page in a manner that is desirable to the user. The user is presented with a plurality of page representation templates from which to choose such that the multiple medical images may be organized on a single page in a format defined by the selected template.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of organizing medical images, said method comprising:
displaying at least two digital medical images in at least one application window of a patient management software application of a computer-based system, wherein each of said digital medical images is identified as being of a particular type of medical image;
displaying at least two page representation templates in at least one other application window of said patient management software application, wherein each of said page representation templates includes pre-defined, blank image holder areas which are each defined as corresponding to a particular type of medical image;
selecting one of said page representation templates based on at least one of said type and number of said displayed medical images;
importing said digital medical images into said selected page representation template, wherein each of said medical images is associated with one of said pre-defined image holder areas based on at least said medical image type; and
displaying said selected page representation template having said imported medical images in an application window of said patient management software application, wherein each of said imported medical images is automatically sized and displayed in an associated image holder area of said selected template.

2. The method of claim 1 further comprising printing at least one hard copy of said selected page representation template with said imported medical images.

3. The method of claim 1 further comprising manually adjusting a size of at least one of said medical images in said displayed selected page representation template.

4. The method of claim 3 further comprising printing at least one hard copy of said selected page representation template with said at least one adjusted medical image.

5. The method of claim 1 wherein said type of medical image comprises at least one of an intra-oral image and a pan-oral image.

6. The method of claim 1 wherein said type of medical image comprises an image being of a certain predefined size.

7. The method of claim 1 wherein said type of medical image comprises an image that is captured using a certain imaging modality.

8. The method of claim 7 wherein said certain imaging modality comprises one of X-ray, ultrasound, magnetic resonance, and infrared.

9. The method of claim 1 wherein said automatic sizing of any said imported medical image is determined by a size of said associated image holder area.

10. The method of claim 1 wherein said at least two digital medical images are initially captured using at least one medical imaging sensor of at least one medical imaging machine.

11. The method of claim 1 further comprising saving said selected page representation template with said imported medical images.

12. The method of claim 1 further comprising saving said selected page representation template with said imported medical images as a document.

13. The method of claim 1 further comprising saving said selected page representation template with said imported medical images as a single image in an image file.

14. A system for organizing medical images, said system comprising a computer-based platform hosting a patient management software application, said computer-based platform used for:
displaying at least two digital medical images in at least one application window of said patient management software application, wherein each of said digital medical images is identified as being of a particular type of medical image;
displaying at least two page representation templates in at least one other application window of said patient management software application, wherein each of said page representation templates includes pre-defined, blank image holder areas which are each defined as corresponding to a particular type of medical image;
selecting one of said page representation templates based on at least one of said type and number of said displayed medical images;
importing said digital medical images into said selected page representation template, wherein each of said medical images is associated with one of said pre-defined image holder areas based on at least said medical image type; and
displaying said selected page representation template having said imported medical images in an application window of said patient management software application, wherein each of said imported medical images is automatically sized and displayed in an associated image holder area of said selected template.

15. The system of claim 14 further comprising at least one printer interfaced to said computer-based platform for printing at least one hard copy of said selected page representation template with said imported medical images.

16. The system of claim 14 further comprising at least one medical imaging machine interfaced to said computer-based platform for capturing said at least two digital medical images and downloading said at least two digital medical images to said computer-based platform.

17. The system of claim 14 wherein said computer-based platform is further used for manually adjusting a size of at least one of said medical images in said displayed selected page representation template.

18. The system of claim 17 further comprising at least one printer interfaced to said computer-based platform for printing at least one hard copy of said selected page representation template with said at least one adjusted medical image.

19. The system of claim 14 wherein said type of medical image comprises at least one of an intra-oral image and a pan-oral image.

20. The system of claim 14 wherein said type of medical image comprises an image being of a certain predefined size.

21. The system of claim 14 wherein said type of medical image comprises an image that is captured using a certain imaging modality.

22. The system of claim 21 wherein said certain imaging modality comprises one of X-ray, ultrasound, magnetic resonance, and infrared.

23. The system of claim 14 wherein said automatic sizing of any said imported medical image is determined by a size of said associated image holder area.

24. The system of claim 14 wherein said computer-based platform is further used for saving said selected page representation template with said imported medical images.

25. The system of claim 14 wherein said computer-based platform is further used for saving said selected page representation template with said imported medical images as a document.

26. The system of claim 14 wherein said computer-based platform is further used for saving said selected page representation template with said imported medical images as a single image in an image file.
